(19) United States
(12) Patent Application Publication
(10) Pub. No.: US 2010/0088448 A1
(43) Pub. Date: Apr. 8, 2010

(54) VIRTUAL COMPUTING ACCELERATOR AND PROGRAM DOWNLOADING METHOD FOR SERVER-BASED VIRTUAL COMPUTING

(75) Inventors: Paul S. MIN, St. Louis, MO (US); Keun-bae KIM, Seoul (KR)

Correspondence Address: CANTOR COLBURN, LLP, 20 Church Street, 22nd Floor, Hartford, CT, 06103, US

(73) Assignees: Paul S. Min, St. Louis, MO (US); INFRANET, INC., Seoul (KR)

(21) Appl. No.: 12/355,350

(22) Filed: Jan. 16, 2009

(30) Foreign Application Priority Data
Oct. 2, 2008 (KR) 10-2008-0097323

(51) Int. Cl. G06F 13/00; G06F 15/16

(52) U.S. Cl. 710/301; 709/231

(57) ABSTRACT

Provided are a virtual computing accelerator and program downloading method for server-based virtual computing. The virtual computing accelerator divides a program allocated to a virtual memory into groups, such as pages or segments, and downloads the groups of program data in sequence. Here, the groups of program data are downloaded after download sequence is estimated on the basis of statistical data accumulated in a hash table, or only a part that must be first downloaded is downloaded in advance. Thus, a program-execution wait time of a client can be reduced. In addition, only a part of a possibly required program is transferred in advance, and the client can execute the application program using only a small amount of virtual memory.

### CROSS REFERENCE TO RELATED APPLICATIONS

This application claims priority from Korean Patent Application No. 10-2008-0097323, filed on Oct. 2, 2008, the disclosure of which is incorporated herein in its entirety by reference.

### BACKGROUND OF THE INVENTION

1. Field of the Invention

The present invention relates to virtual computing technology, and more particularly, to a virtual computing accelerator for high-performance virtual computing and a program downloading method for server-based virtual computing.

2. Description of the Related Art

Virtual computing technology has been used since the UNIX era. According to virtual computing technology, all application programs are installed and executed in a server, and only the execution results are transferred to client terminals. More specifically, as illustrated in FIG. 1, client terminals (mobile terminals, personal notebooks, desktop personal computers (PCs), etc.) consist of only input/output (I/O) devices (a keyboard, a mouse, a display, etc.), and all application programs are executed in a central server 100.

According to virtual computing technology, the application programs are managed by the central server 100, and the client terminals do not need to continuously upgrade the application programs. Using any computing devices, clients can access their own application programs and data stored in a web storage 102, and can conveniently use their own application programs or those of groups they belong to at any place. In addition to these advantages, according to server-based computing technology, total cost of ownership (TCO) is saved. Furthermore, all data in an enterprise can be managed at the center, and thus it is possible to ensure excellent security and management.

While having the above-mentioned advantages, server-based virtual computing technology also has some limitations. According to conventional server-based computing technology, all application programs are executed in a central server and only the results are transferred to client terminals, as mentioned above. Thus, clients may experience a relatively long response time when a large amount of data is transferred. In addition, the probability of data loss may be high when a large amount of data is transferred in an unstable communication environment.

To overcome these limitations, a technique of streaming application programs has been provided. More specifically, when a client selects a specific application program, the application program is downloaded to a client terminal and executed. In this method, the client may feel that the interaction is excellent, but must wait until the application program is downloaded to the client terminal. Here, the wait time may increase according to network state.

### SUMMARY OF THE INVENTION

The present invention provides a virtual computing accelerator using a faster computing technique than a general server-based virtual computing technique, and a program downloading method for server-based virtual computing.

The present invention also provides a virtual computing accelerator which downloads, in advance, parts first required to execute a program selected by a client when downloading the program and thus can minimize a wait time, and a program downloading method for server-based virtual computing.

The present invention also provides a virtual computing accelerator which assigns priority orders to the download sequence of the corresponding program on the basis of a client's program use history and thus can minimize a wait time, and a program downloading method for server-based virtual computing.

The present invention also provides a virtual computing accelerator capable of reducing the load of a server downloading a program to a client.

The present invention also provides a virtual computing accelerator capable of supporting a client to execute an application program using a small amount of virtual memory, and a program downloading method for server-based virtual computing.

Additional aspects of the invention will be set forth in the description which follows, and in part will be apparent from the description, or may be learned by practice of the invention.

The present invention discloses a program downloading method for server-based virtual computing including: dividing program data allocated to a virtual memory into groups and accessing the groups of program data in sequence while estimating a next group to download; and transferring the accessed groups of program data to a client.

The dividing of the program data may include: updating a hash table by accumulating statistical data of next download groups in an index of a current download group; and estimating the next group to download on the basis of the hash table.

The present invention also discloses a virtual computing accelerator including: a first interface for interfacing program data allocated to a virtual memory; a processor for dividing the program data allocated to the virtual memory into groups and accessing the groups of program data in sequence while estimating a next group to download; a stream controller for transferring the groups of program data accessed by the processor to a client; and a second interface for transferring the program data to the client.

The processor may update a hash table by accumulating statistical data of next download groups in an index of a current download group and estimate the next download group to access on the basis of the hash table.

The virtual computing accelerator may further include: a bridge interface for interfacing with a server processor; and a mode selection switch for connecting one of the processor and the server processor with the first interface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram illustrating the concept of general server-based virtual computing.

FIG. 2 is a block diagram of a server motherboard including a virtual computing accelerator according to an exemplary embodiment of the present invention.

FIG. 3 is a diagram for illustrating a program download estimation technique.

FIG. 4 is an example of a hash table according to an exemplary embodiment of the present invention.

FIG. 5 is a flowchart showing a program downloading operation for server-based virtual computing according to an exemplary embodiment of the present invention.

FIG. 6 is a block diagram of a virtual computing accelerator according to another exemplary embodiment of the present invention.

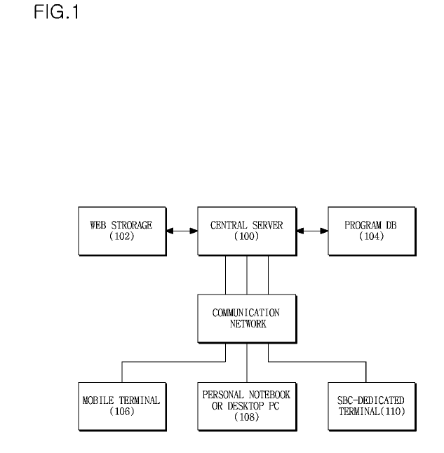

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It is to be understood that the term “program” used in the descriptions below includes operating systems (OSs) as well as application programs, and the term “group” denotes units accessed according to page or segment.

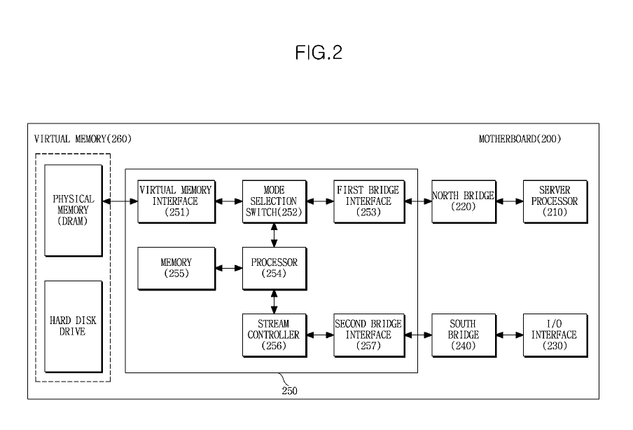

A virtual computing accelerator according to an exemplary embodiment of the present invention will be described below. FIG. 2 is a block diagram of a server motherboard 200 including a virtual computing accelerator 250 according to an exemplary embodiment of the present invention.

Referring to FIG. 2, a server processor 210 controlling the overall operation of a server, a north bridge 220, a south bridge 240, an input/output (I/O) interface 230, and a virtual memory 260 are mounted on the motherboard 200 of the server for virtual computing. In addition to the general structure, the virtual computing accelerator 250 is disposed between the virtual memory 260 and both bridges 220 and 240 on the motherboard 200. The accelerator 250 accesses program data allocated to the virtual memory 260 in units of groups, for example, pages, and transfers the groups of program data to the I/O interface 230 in sequence by streaming.

As illustrated, the accelerator 250 includes a virtual memory interface 251, that is, a first interface, a mode selection switch 252, a processor 254, a stream controller 256, and a second bridge interface 257, that is, a second interface. The virtual memory interface 251 interfaces the program data allocated to the virtual memory 260. The mode selection switch 252 connects one of the processor 254 in the accelerator 250 and the server processor 210 with the virtual memory interface 251. The processor 254 divides the program data allocated to the virtual memory 260 into groups, for example, pages, and accesses the groups of program data according to an estimated sequence. The stream controller 256 transfers the groups, e.g., pages, of program data accessed by the processor 254 to a client by streaming. The second bridge interface 257 interfaces the program data transferred through the stream controller 256 with the client. The mode selection switch 252 controlling access to the virtual memory 260 may be removed from the constitution of the accelerator 250 according to the design of the motherboard 200.

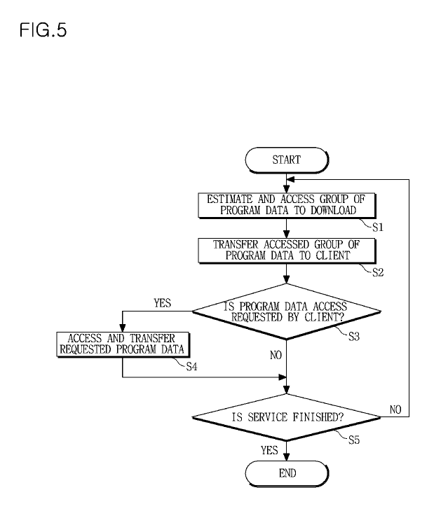

Meanwhile, the processor 254 in the accelerator 250 accumulates statistical data for determining a download sequence of the program data divided into groups, e.g., pages, in a hash table, estimates groups, e.g., pages, of program data to be transferred according to the accumulated statistical data, and downloads the groups of program data in sequence. The hash table may be generated in a memory which may be included in the processor 254, or in a separate memory 255 disposed outside the processor 254. In the hash table generated in a memory, statistical data of a next page to be downloaded is accumulated in the respective group indexes, e.g., page indexes, separated as illustrated in FIG. 4. The hash table is generated for each client according to program and continuously updated. Here, the processor 254 may download pages of program data in sequence on the basis of previously defined default data until a specific amount of statistical data is accumulated. The memory 255 may also be used to temporarily store data accessed by the virtual memory 260.

When a wrong page is estimated and downloaded according to statistical data, a correct page of data needs to be downloaded again. To this end, the stream controller 256 in the accelerator 250 accesses and downloads a page requested by a fetch program installed in a client. In this case, the client has to wait until the new page is downloaded.

Thus far, the constitution of the virtual computing accelerator 250 according to an exemplary embodiment of the present invention has been described together with the constitution of the server motherboard 200 including the virtual computing accelerator 250. Operation of the virtual computing accelerator 250 will be described in detail below.

To start one program or perform one function in a client, an OS and a part of the application program are required. Thus, if only the required part is correctly estimated and downloaded to the client, the client can start the program quickly.

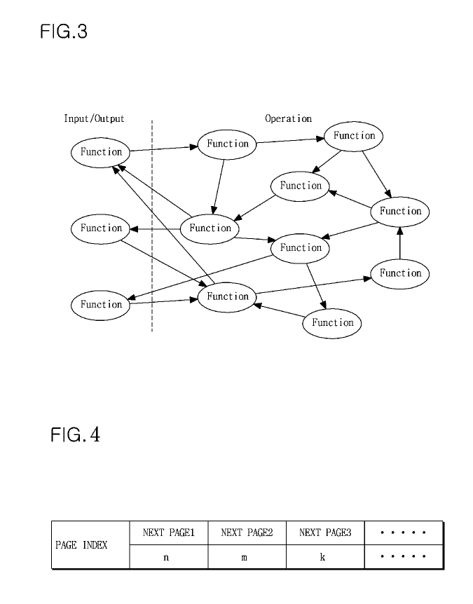

A method of downloading only the required part is as follows. As illustrated in FIG. 3, a next state may be estimated from a current state according to client by analyzing, for example, the use pattern of an application program. Thus, when a server estimates and downloads a possibly required part of a virtual memory in advance, a client can start the application program or normally perform a required function using only a small amount of virtual memory.

To this end, the accelerator 250 according to an exemplary embodiment of the present invention accumulates statistical data for determining a download sequence of program data divided into pages, and estimates and downloads the pages of program data according to the accumulated statistical data.

This will be described with reference to FIGS. 2 and 5. First, when a client requests program download, the server processor 210 controls the mode selection switch 252 to generate one virtual memory 260 logically consisting of a hard disk drive and a memory as illustrated in FIG. 2, and allocates a selected program to the virtual memory 260. For example, Windows XP can have a virtual memory of 4 GB, and the virtual memory 260 is divided into 4 KB pages.

When generation of the virtual memory 260 is completed, the mode selection switch 252 switches such that the processor 254 in the accelerator 250 can access the virtual memory 260. When statistical data for determining a download sequence of a program to download is not accumulated, the processor 254 accesses and transfers the program in units of pages in a sequence defined in default data to the stream controller 256 until a specific amount of statistical data is accumulated. Then, the stream controller 256 downloads the received pages of program data in sequence through the I/O interface 230. In the client, the application program starts on the basis of a page of program data first downloaded from the virtual memory 260.

Consequently, an exemplary embodiment of the present invention downloads a part of a selected program required for starting the program, rather than the entire program, to a client, thereby reducing a time taken for the client to start the program.

Meanwhile, when a request to perform a function is received from a client executing a program, the processor 254 downloads a page in which program data required to perform the function is recorded. In this case, the processor 254 records information on the downloaded page in a hash table. For example, when a currently downloaded page index is “5” and a previously downloaded page index is “10”, the processor 254 updates the hash table by increasing a probability value that the page index “10” is switched to the page index “5” by 1 as illustrated in FIG. 4.

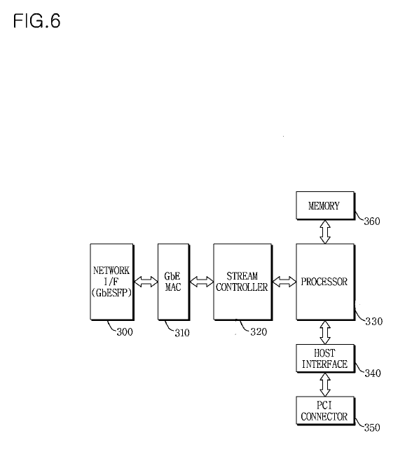

When the hash table is updated in this way every time a page is downloaded, a use pattern of each client is generated whereby it is possible to estimate to which state a program switches from a current state. Thus, when the statistical data of a group to download next to each page index is accumulated, the processor 254 can estimate and access a page to download next on the basis of the accumulated statistical data. When the processor 254 estimates and accesses a group of program data to download next on the basis of the hash table and transfers it to the stream controller 256 (step 1 of FIG. 6), the accessed group of program data is transferred to the client through the stream controller 256 and the second bridge interface 257 (step 2). In this way, the client can normally use functions of the application program using a small amount of virtual memory, and excellent interaction can be expected as well.

Meanwhile, an expected and downloaded page may not be needed. In this case, the stream controller 256 communicates with a fetch program installed in the client and downloads a newly requested page of program data (S3 and S4). More specifically, the stream controller 256 requests the processor 254 to access a page of program data for performing a function requested by the fetch program installed in the client, and downloads the page of program data received in response to the request to the client. Inevitably, it takes time to download the requested page, but there is no problem in performing the function.

As described above, an exemplary embodiment of the present invention divides a program allocated to a virtual memory into groups, such as pages or segments, and downloads the groups of program data in sequence. Here, the groups of program data are downloaded after a download sequence is estimated according to statistical data based on a program use history (pattern), or only a part that must be first downloaded is downloaded in advance. Thus, a program-execution wait time of a client can be reduced. In addition, only a part of a possibly required program is downloaded in advance, and the client can execute the application program using only a small amount of virtual memory.

In the above exemplary embodiment, the virtual computing accelerator 250 which can be mounted on a server motherboard has been described. However, a virtual computing accelerator according to an exemplary embodiment of the present invention can be manufactured in the form of a card which can be inserted into a peripheral component interconnect (PCI) slot. The constitution of a virtual computing accelerator which can be manufactured in card form is illustrated in FIG. 6.

Referring to FIG. 6, the virtual computing accelerator which can be manufactured in card form includes a host interface 340, that is, a first interface, a processor 330, a stream controller 320, and a second interface unit. The host interface 340 interfaces program data allocated to the virtual memory of the host. The processor 330 divides the program data allocated to the virtual memory into groups and accesses a group of program data in sequence while estimating a next download group. The stream controller 320 transfers the group of program data accessed by the processor 330 to a client. The second interface unit transfers the program data to the client.

In addition, a PCI connector 350 connects the virtual computing accelerator which can be manufactured in card form to a PCI slot. A memory 360 consisting of a dynamic random-access memory (DRAM) and a flash disk stores program data for controlling the overall operation of the card and may temporarily store the program data allocated to the virtual memory of the host before it is stored in the client. The memory 360 may be implemented in one chip together with a processor. A gigabit Ethernet (GbE) media access control (MAC) 310 directly manages data communication with outside. Here, a GbE may be a 10-gigabit Ethernet according to network connection requirements.

Meanwhile, like the processor 254 illustrated in FIG. 2, the processor 330 also updates a hash table by accumulating statistical data of groups to download next in an index of a current download group and estimates a next download group to access on the basis of the hash table. The processor 330 generates program-specific hash tables for each client. As described with reference to FIG. 2, the stream controller 320 also accesses and downloads a group of program data requested by a fetch program installed in a client.

As described with reference to FIG. 5, the virtual computing accelerator having the above-described constitution also divides a program allocated to a virtual memory into groups, such as pages or segments, and downloads the groups of program data in sequence. Here, the groups of program data are downloaded after a download sequence is estimated on the basis of statistical data accumulated in a hash table, or only a part that must be first downloaded is downloaded in advance. Thus, a program-execution wait time of a client can be reduced. In addition, only a part of a possibly required program is downloaded in advance, and the client can execute the application program using only a small amount of virtual memory

In exemplary embodiments of the present invention, programs (an OS as well as application programs) allocated to a virtual memory are divided into groups and downloaded in sequence. Here, a download sequence is estimated according to statistical data based on a program use history, or a part that must be first downloaded is downloaded in advance. Thus, a program-execution wait time of a client can be reduced. As a result, it is possible to provide a faster computing technique than general virtual computing technology.

A processor in an accelerator according to an exemplary embodiment of the present invention directly accesses a virtual memory through a mode selection switch and downloads a program such that the load of a server processor involved in download can be reduced.

In exemplary embodiment of the present invention, only a part of a possibly required program is downloaded in advance, and thus a client can execute the application program using only a small amount of virtual memory.

An accelerator according to an exemplary embodiment of the present invention may be provided in the form of a chip which can be mounted on a server motherboard or a card which can be inserted into a PCI slot.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A virtual computing accelerator, comprising:
a first interface for interfacing program data allocated to a virtual memory;
a processor for dividing the program data allocated to the virtual memory into groups and accessing the groups of program data in sequence while estimating a next group to download;
a memory for temporarily storing the accessed program data;
a stream controller for transferring the groups of program data accessed by the processor to a client; and
a second interface for transferring the program data to the client.

2. The virtual computing accelerator of claim 1, wherein the processor updates a hash table by accumulating statistical data of next download groups in an index of a current download group, and estimates the next download group on the basis of the hash table.

3. The virtual computing accelerator of claim 2, wherein the processor generates program-specific hash tables for each client.

4. The virtual computing accelerator of claim 1, wherein the stream controller accesses and downloads a group of program data requested by a fetch program installed in the client.

5. The virtual computing accelerator of claim 1, wherein the first interface is a host interface, and the virtual computing accelerator is a card inserted into a peripheral component interconnect (PCI) slot.

6. The virtual computing accelerator of claim 1, further comprising:
a bridge interface for interfacing with a server processor; and
a mode selection switch for connecting one of the processor and the server processor with the first interface.

7. The virtual computing accelerator of claim 6, wherein the processor updates a hash table by accumulating statistical data of next download groups in an index of a current download group, and estimates the next download group to access on the basis of the hash table.

8. The virtual computing accelerator of claim 7, wherein the processor generates program-specific hash tables for each client.

9. The virtual computing accelerator of claim 6, wherein the stream controller accesses and downloads a group of program data requested by a fetch program installed in the client.

10. The virtual computing accelerator of claim 6, wherein the first interface is a virtual memory interface, and the virtual computing accelerator is a chip mounted on a motherboard.

11. A program downloading method for server-based virtual computing, comprising:
dividing program data allocated to a virtual memory into groups and accessing the groups of program data in sequence while estimating a next group to download; and
transferring the accessed groups of program data to a client.

12. The program downloading method of claim 11, wherein the dividing of the program data comprises:
updating a hash table by accumulating statistical data of next download groups in an index of a current download group; and
estimating the next group to download on the basis of the hash table.

13. The program downloading method of claim 12, wherein the hash table is generated for each client according to program.

14. The program downloading method of claim 11, further comprising:
accessing and downloading a group of program data requested by a fetch program installed in the client.

15. The virtual computing accelerator of claim 2, wherein the first interface is a host interface, and the virtual computing accelerator is a card inserted into a peripheral component interconnect (PCI) slot.

16. The virtual computing accelerator of claim 3, wherein the first interface is a host interface, and the virtual computing accelerator is a card inserted into a peripheral component interconnect (PCI) slot.

17. The virtual computing accelerator of claim 4, wherein the first interface is a host interface, and the virtual computing accelerator is a card inserted into a peripheral component interconnect (PCI) slot.

18. The virtual computing accelerator of claim 7, wherein the first interface is a virtual memory interface, and the virtual computing accelerator is a chip mounted on a motherboard.

19. The virtual computing accelerator of claim 8, wherein the first interface is a virtual memory interface, and the virtual computing accelerator is a chip mounted on a motherboard.

20. The virtual computing accelerator of claim 9, wherein the first interface is a virtual memory interface, and the virtual computing accelerator is a chip mounted on a motherboard.
